(19) United States
(12) Patent Application Publication
(10) Pub. No.: US 2006/0049589 A1
(43) Pub. Date: Mar. 9, 2006

(54) Sled

(75) Inventor: Ulrich Ewringmann, Taufkirchen (DE)

Correspondence Address: PYLE & PIONTEK, 221 N. LASELLE STREET, SUITE 850, CHICAGO, IL, 60601, US

(73) Assignee: Franz Schneider GmbH & Co. KG

(21) Appl. No.: 11/222,252

(22) Filed: Sep. 8, 2005

(30) Foreign Application Priority Data
Jun. 15, 2005 (EP) 05012822.2
Sep. 9, 2004 (DE) 102004043582.0

(51) Int. Cl. B62B 17/00

(52) U.S. Cl. 280/20

(57) ABSTRACT

The sled is composed of two sled halves which are articulated via hinge means to each other such that the sled can be collapsed about its longitudinal center axis. In the unfolded state an upper section of a scissor-like bar rests with its bottom side on the top side of the associated other scissor-like bar. Thanks to this flat support of the scissor-like bars on one another, the sled is very stable. The unfolded operative state of the sled is automatically secured by the releasable locking mechanism.

The present invention relates to a sled according to the preamble of patent claim 1.

A conventional sled needs a lot of space because of its shape which is rectangular in cross section, so that it happens very often that it can e.g. not be accommodated in the trunk of a motor vehicle together with other pieces of luggage and must often be mounted on a luggage rack. If such a sled has to be carried under specific situations, this may be very difficult especially for small children.

It is the object of the present invention to provide a sled which needs much less space and which can be carried easily. Furthermore, it is to be ensured that the sled in its unfolded operative state has the necessary stability to withstand the forces acting thereon and to reliably maintain the unfolded state.

According to the invention said object is achieved by the features of patent claim 1.

According to the invention, the sled is composed of two sled halves which are articulated to each other via hinge means such that the sled can be collapsed about its longitudinal center axis.

Preferably, each of the sled halves includes a runner section which passes into a front transverse bar that is provided at its free end with an eye-like or hinge-like articulated section, and two further scissor-shaped transverse bars mounted on the runner section, which are each connected at their ends by a seat bar which extends in longitudinal direction and has a flexible seat element secured thereto, and the scissor-like bars are each provided at an intermediate position with eye-like or hinge-like articulated sections. The seat element is preferably a canvas or fabric that is stretched between the two seat bars in the unfolded operative state of the sled.

Furthermore, all of the hinge-like articulated sections are in alignment with one another and a connection rod of a preferably circular round cross-section extends through the articulated sections. Said connection rod which is preferably of a tubular shape expediently projects slightly over the front and rear eye sections and may e.g. be provided with a fastening cap of increased diameter, said caps being firmly mounted on the two ends of the connection rod. Other means may also be provided that reliably fix the connection rod in its mounted position.

Instead of a single continuous connection rod or connection tube, each articulated section may also be equipped with associated short hinge pins.

Particularly advantageously, an upper section of the two scissor-like bars rests with its bottom side in the unfolded state of the sled on the top side of the lower section of the respectively associated other scissor-like bar, the seat fabric being stretched in said state, as has been mentioned above. Thanks to this planar or flat support of the scissor-like bars on one another, the sled is very stable.

With great advantage it is also suggested that the sled in the unfolded operative state should be secured by a releasable locking mechanism. It is here preferred that the locking mechanism includes a locking sleeve which is displaceable in axial direction and locks the hinge-like articulated sections of at least one pair of the scissor-like bars in the unfolded state of the sled. Expediently, both hinge portions of the scissor-like transverse rods are provided with such a locking mechanism.

The locking sleeve may comprise at least one outwardly facing projection which is seated in an accommodating chamber of one of the hinge-like articulated sections, said accommodating chamber laterally enclosing the projection with a slight play and being open towards the adjoining other hinge-like articulated section, and the other hinge-like articulated section comprises a surrounding front boundary wall with a recess through which an axial section of the projection can enter into a corresponding receiving chamber. Preferably, the locking sleeve comprises two diametrically opposite projections of such a type, said projections radially projecting outwards from the locking sleeve.

Furthermore, the locking sleeve is biased by a spring means, preferably a coil spring which surrounds the locking sleeve, into the locking direction.

The locking sleeve is firmly connected to the connection rod, so that it can be displaced again, by displacing the connection rod in a direction opposite to the locking direction, into the release position in which the locking sleeve exits again out of the one hinge-like articulated section.

The bars of the two slide halves are expediently given an elongated rectangular shape when viewed in cross section. The two sled halves preferably consist of a plastic material and are made in one piece, so that the sled which is composed of few parts can be produced at relatively low costs.

Further details of the invention become apparent from the following description of two preferred embodiments and with reference to the drawings, in which:

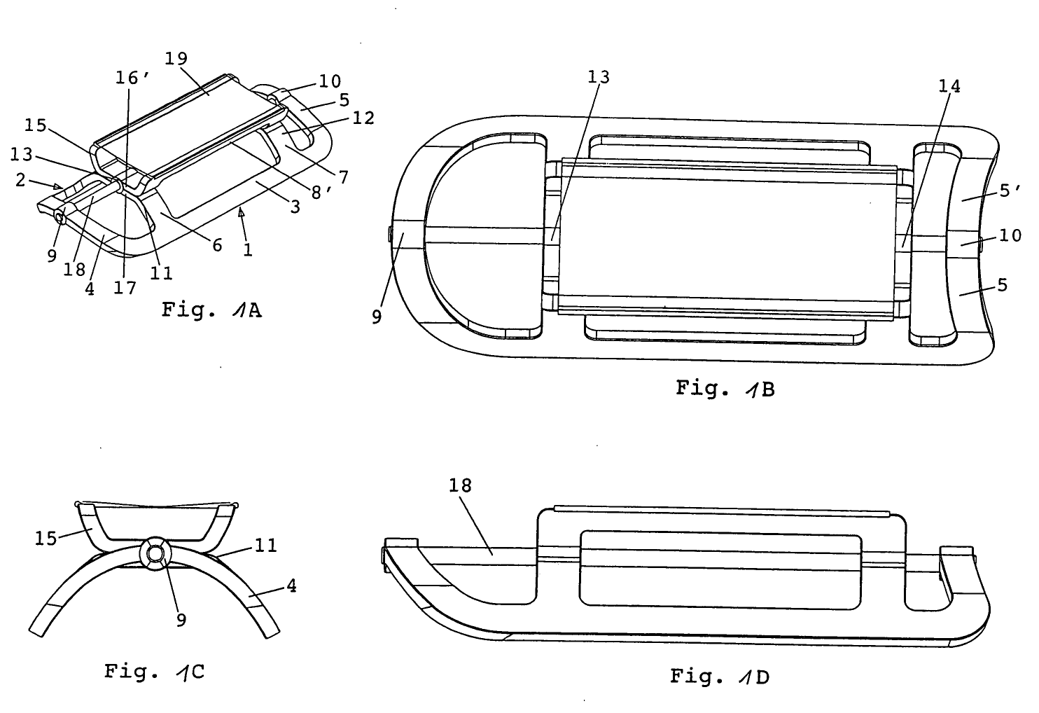

FIGS. 1A to 1D show a first embodiment of the sled in a perspective view, a top view, a front end view, and a side view;

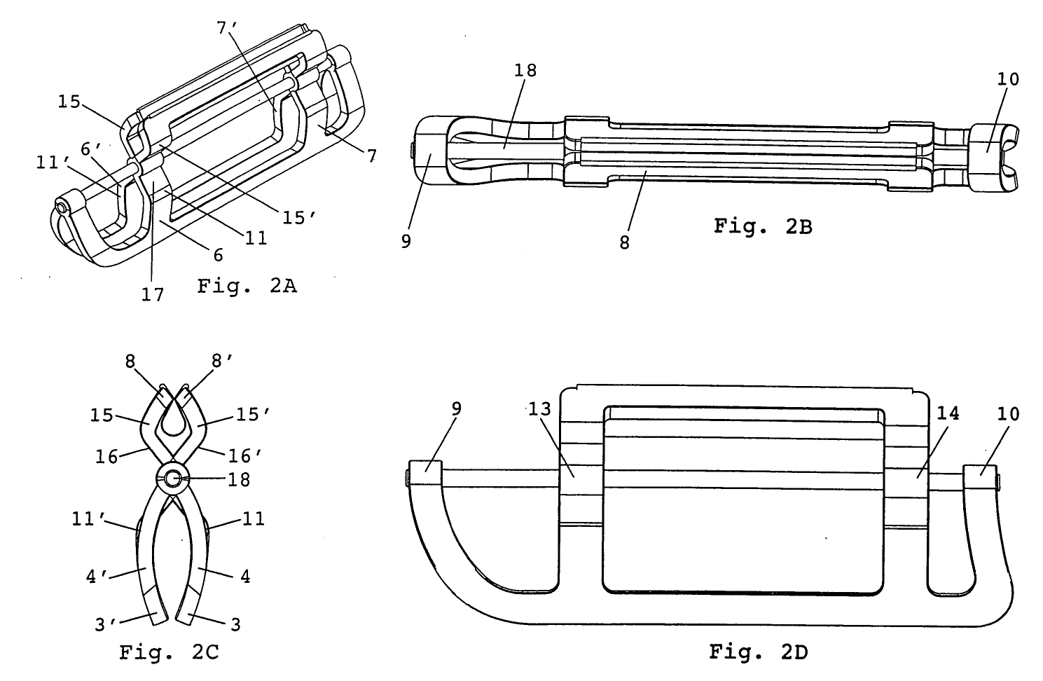

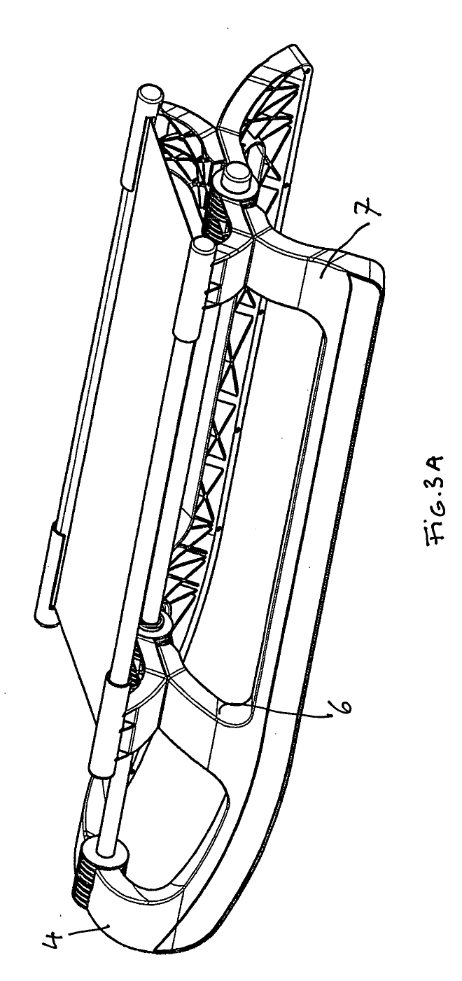

FIGS. 2A to 2D show the sled of FIG. 1 in corresponding illustrations in the collapsed state;

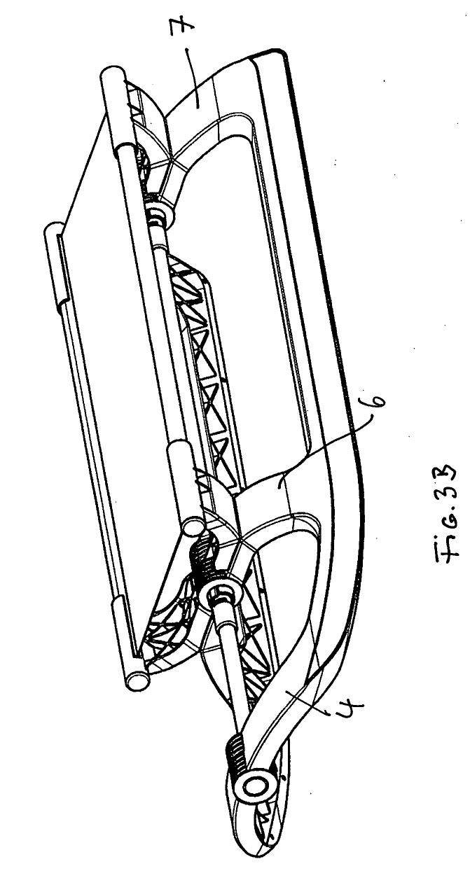

FIGS. 3A and 3B show a second embodiment of the sled in perspective views obliquely from the rear and obliquely from the front;

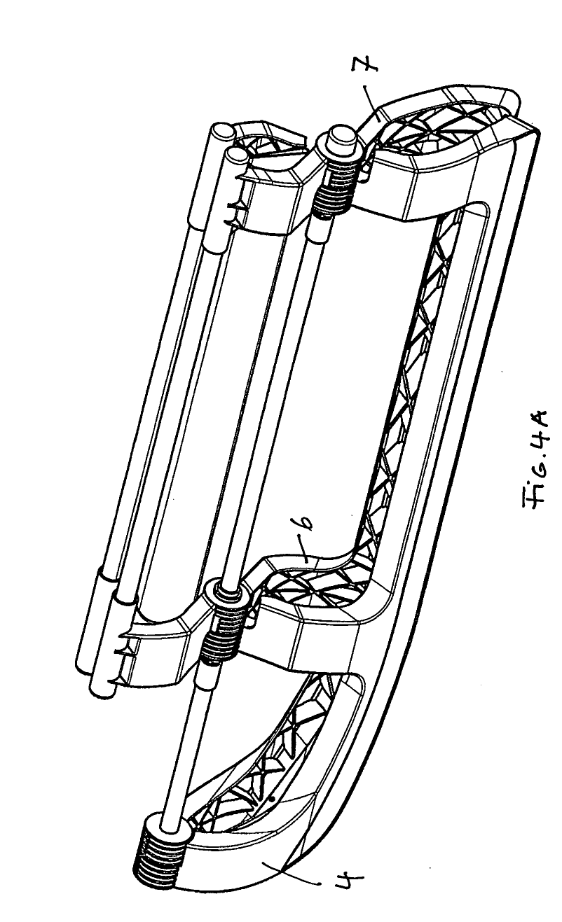

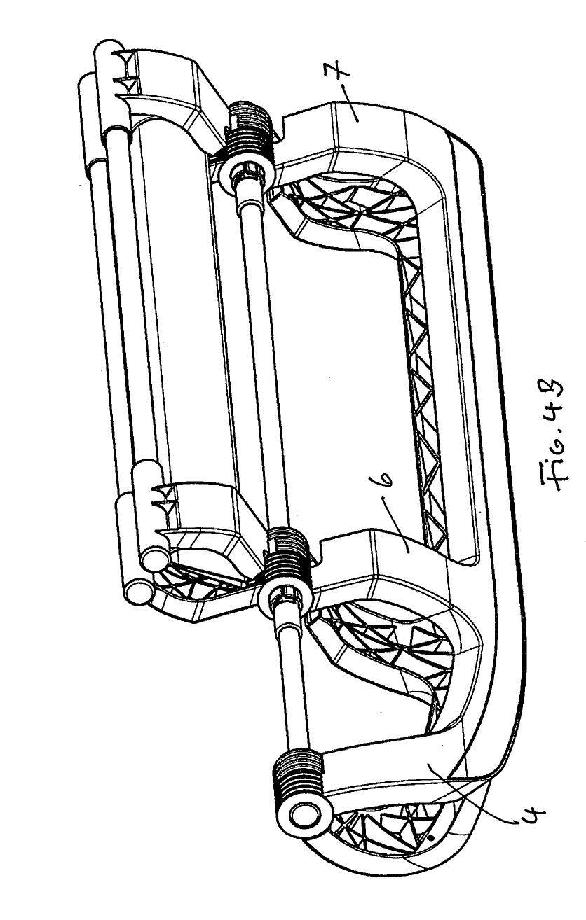

FIGS. 4A and 4B show the sled of FIG. 3 in the collapsed state in two perspective views;

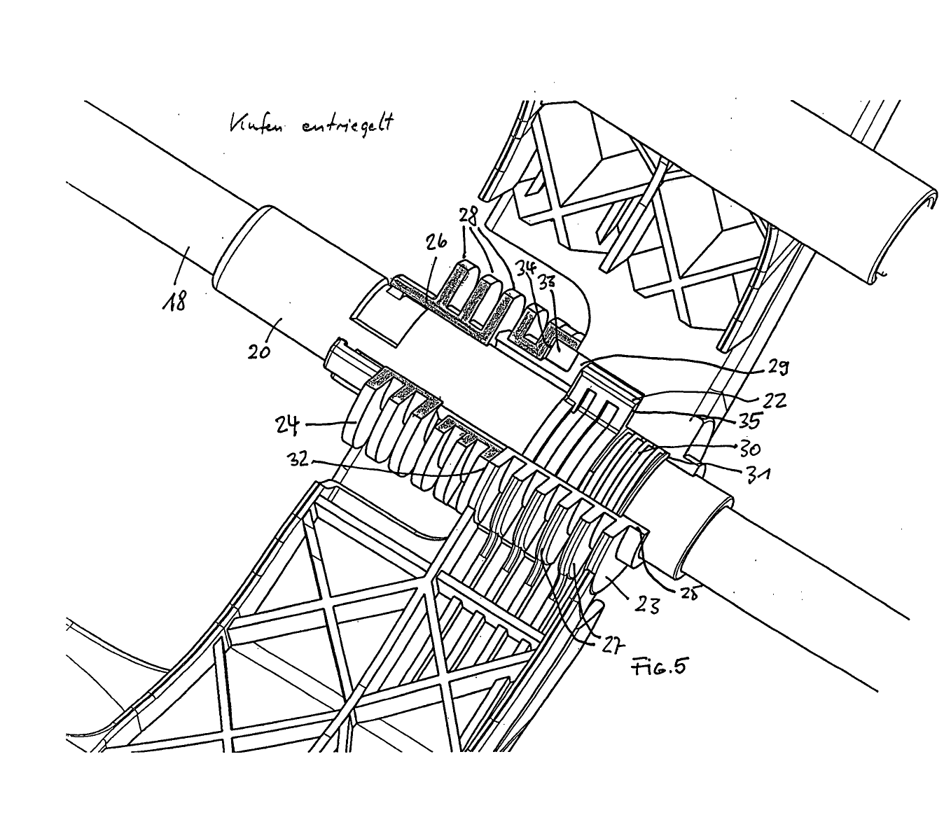

FIG. 5 is a partly cut illustration of the hinges of the scissor-like transverse bars, in the unlocked state of the runners;

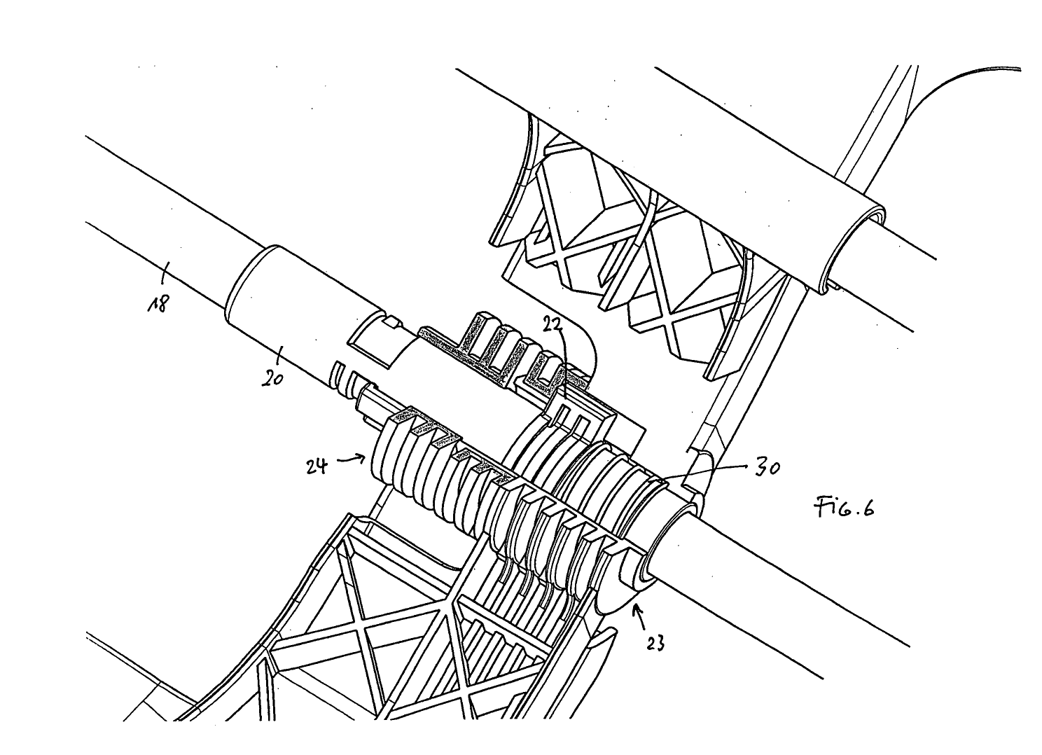

FIG. 6 shows the locked state of the runners in the unfolded operative state of the sled; and

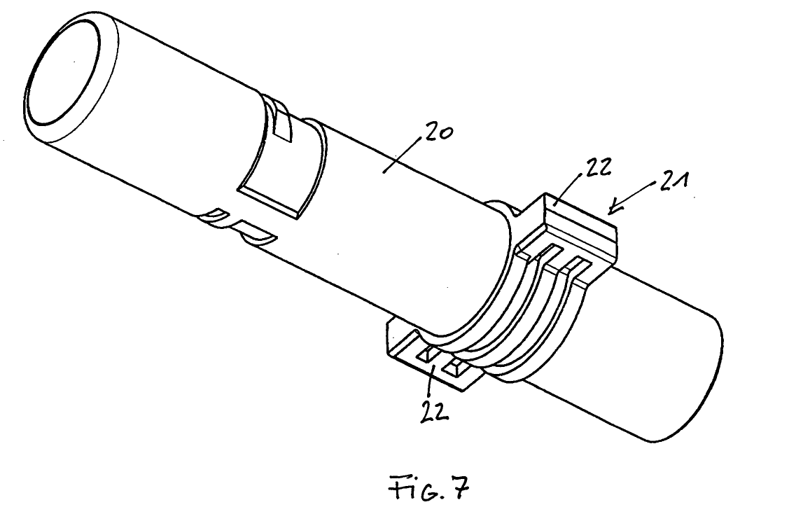

FIG. 7 is a perspective illustration of the locking sleeve of the hinges.

FIGS. 1A to 1D show the sled according to the invention in the unfolded operative state. The sled includes two sled halves 1, 2 which are configured in mirror-inverted fashion relative to each other. Each sled half 1, 2 consists of a one-piece plastic member which comprises a runner section 3 which at its front and rear end passes into a front transverse bar 4 and a rear transverse bar 5, and which has attached thereto, at a distance from the transverse bars 4 and 5, scissor-like bars 6, 7 which are also spaced apart from each other and which at their free ends are connected by a seat bar 8 which extends in the longitudinal direction of the sled.

The transverse bars 4, 5 of the two sled halves 1, 2 are each provided at their free ends with one or more eyes or hinges 9, 10. For instance, the transverse bars 4 and 5 of the one sled half 1 may each be provided with an eye 9 and 10 while the transverse bars 4′ and 5′ of the other sled half 2 are also provided with a respective eye which is axially offset such that the two eyes of one eye-like articulated section rest on each other. Of course, each of the transverse bars 4, 4′ and 5, 5′ of the two sled halves 1 and 2 may also be provided with a plurality of eyes 9 and 10 which are offset relative to each other and mutually arranged one after the other.

The approximately S-shaped scissor-like bars 6 and 7 consist each of a lower section 10 and 11, respectively, which terminate in eyes 13 and 14 corresponding to eyes 9 and 10, and of an upper section 15 and 16 provided at the other sled side.

The scissor-like bars 11 and 12 of the two sled halves 1 and 2 are shaped such that a portion 16 of the upper section of the scissor-like bars 6 and 7 rests flat on a portion 17 of the lower section 11 of the scissor-like bars 6 and 7 when the sled is in the unfolded operative position. This means that at both sides of the eye-like articulated sections 13 and 14 the scissor-like bars of the two sled halves 1 and 2 evenly rest on one another preferably with flat surfaces or with correspondingly curved surfaces, whereby the sled is very stable.

A connection rod or connection tube 18 of a circular cross-section which can slightly project beyond the outer eyes 9 and 10 and may there e.g. be secured by a cap of increased diameter extends through the eyes 9, 13, 14 and 10.

A seat element 19 in the form of a canvas or fabric is stretched between the seat bars 8 when the sled is unfolded.

In FIGS. 2A and 2C, the two right scissor-like bars are designated by 6 and 7 while the associated bars of the other sled half are designated by 6′ and 7′. The lower and upper sections are designated accordingly with 11, 15 and 11 ′ and 15′.

FIGS. 2A to 2D which show the sled in the collapsed state reveal that the space required by the collapsed sled is much smaller because its width is minimal by virtue of substantially adjoining runner sections 3 and 3′ and adjoining seat bars 8 and 8′.

FIGS. 3 and 4 show another embodiment of the sled in which the rear transverse bars 5 and 5′ of the first embodiment have been omitted. Hence, this sled only contains the front transverse bars 4 and the scissor-like bars 6 and 7.

FIGS. 5, 6, and 7 show the locking mechanism of the two hinge portions of the scissor-like transverse bars 6 and 7. The connection rod 18 has secured thereto a locking sleeve 20 to which a locking element 21 is fastened that comprises two diametrically arranged and radially projecting locking pegs 22. The hinge-like articulated sections 23 and 24 of the associated scissor-like bars 6 or 7 of the two sled halves are seated in axially adjoining fashion on the locking sleeve. Each of the hinge-like sections 23 and 24 includes an inner eye-like or tubular section 25, 26 and lamellar reinforcing ribs 27 and 28 formed thereon.

The locking pegs 22 of the locking sleeve are seated in bag-like receiving pockets 29 of the hinge-like articulated section 23, so that the hinge-like articulated section 23 can only rotate together with the locking sleeve 20 and the connection rod 18. The locking sleeve 20 is biased by a coil spring 30 towards the other hinge-like articulated section 24, the coil spring 30 being supported on the one hand on the lateral flanks of the locking pegs 22 and on the other hand on an annular shoulder 31 of the hinge-like articulated section 23.

A surrounding annular front wall 32 of the hinge-like articulated section 24 closes the exit openings of the receiving chambers 29 of the locking pegs 22 until two recesses in the annular front wall 32 are in alignment with the exit openings of the receiving chambers 29, so that the locking pegs 22 can enter with their front section into corresponding receiving chambers 33 of the hinge-like articulated section 24 until abutment on the boundary walls 34 thereof. When this is the case, the two hinge-like articulated sections 23, 24 of the scissor-like bars are locked relative to one another, so that the sled cannot be collapsed. The locking position is shown in FIG. 6.

The locked state is released again in that the connection rod 18 with the locking sleeve 20 is pressed back against the force of spring 30 until abutment on the boundary wall 35 of the receiving chamber 29, whereby the hinge-like articulated sections can be rotated again relative to each other.

The unfolded operative state of the sled is thus automatically secured by the releasable locking mechanism.

1. A sled
characterized in
that the sled is composed of two sled halves (1, 2) which are articulated to each other via hinge means (9, 13, 14, 10) such that the sled can be collapsed about its longitudinal center axis.

2. The sled according to claim 1,
characterized in
that each of the sled halves (1, 2) comprises a runner section (3, 3′) which passes into a front transverse bar (4, 4′) which is provided at its free end with an eye-like articulated section (9), and scissor-like bars (6, 6′; 7, 7′) attached to the runner section, which at their free ends are each connected by a seat bar (8, 8′) extending in longitudinal direction, which has secured thereto a flexible seat element (19), the scissor-like bars being each provided at an intermediate position with eye-like or hinge-like articulated sections (13, 14).

3. The sled according to claim 2,
characterized in
that all hinge-like articulated sections (8, 13, 14, 10) are in alignment with one another and that a connection rod (18) of a circular round cross-section extends through the articulated sections.

4. The sled according to claim 2,
characterized in
that an upper section (16, 16′) of a scissor-like bar (6, 6′; 7, 7′) rests with its bottom side in the unfolded state of the sled on the top side (17, 17′) of the associated other scissor-like bar.

5. The sled according to claim 2,
characterized in
that the unfolded state of the sled is secured by a releasable locking mechanism, the locking mechanism including a locking sleeve (20) which is displaceable in axial direction and which locks the hinge-like articulated sections (23, 24) of at least one pair of scissor-like bars (6 or 7) in the unfolded state of the sled.

6. The sled according to claim 5,
characterized in
that the locking sleeve (20) comprises at least one outwardly oriented projection (22) which is seated in a receiving chamber (29) of a hinge-like articulated section (23), the receiving chamber (29) being open towards the adjoining other hinge-like articulated sections (24), and that the other hinge-like articulated section (24) comprises a front boundary wall (32) with a recess through which an axial section of the projection (22) can enter into a corresponding receiving chamber (22).

7. The sled according to claim 5,
characterized in
that the locking sleeve (20) is biased by a spring means (30) into the locking direction.

8. The sled according to claim 5,
characterized in
that the locking sleeve (20) is firmly connected to the connection rod (18).

9. The sled according claim 1,
characterized in
that the two sled halves (1, 2) are each made in one piece from plastics.
